(19) United States
(12) Patent Application Publication
(10) Pub. No.: US 2008/0309869 A1
(43) Pub. Date: Dec. 18, 2008

(54) Ear-propped device with an elastic band

(76) Inventor: Chin-Jen Chen, An Ting Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/808,577

(22) Filed: Jun. 12, 2007

(51) Int. Cl. G02C 11/00

(52) U.S. Cl. 351/155

(57) ABSTRACT

An ear-propped device includes two ear-hung parts, and an elastic band; each ear-propped part includes a hooking portion, which is made to have a curvature according to a curvature of a joint between a person's ear and head; each ear-propped part has a connecting portion to be joined to a corresponding temple of a pair of eyeglasses; the ear-propped parts are formed on two ends of the elastic band; in use, the ear-propped parts are joined to rear ends of temples of a pair of eyeglasses respectively, with the hooking portions thereof being hooked over hinder portions of the ears of a person wearing the eyeglasses, such that the eyeglasses and the elastic band together form a loop, and are tight around the wearer's head; thus, the eyeglasses are firm and prevented from falling off.

### BACKGROUND OF THE INVENTION

1. Field of the Invention

The present invention relates to an ear-propped device with an elastic band, more particularly one, which is used together with eyeglasses to make the eyeglasses firm, and prevent the eyeglasses from falling off the wearer.

2. Brief Description of the Prior Art

Common eyeglasses for assisting the sight, e.g. those for near-sightedness and far-sightedness, include a front, and two temples, which are connected to the front, and have at rear ends thereof earpieces to be propped on and hooked over the wearer's ears for holding the eyeglasses in place. Such eyeglasses are prone to move away from the proper position and evenly fall off to get damaged when the wearer is playing ball games or participating in athletic contests.

To overcome the above problem, an ear-propped device is provided for use with eyeglasses, which includes a pair of ear-propped parts. In use, the ear-propped parts are joined to rear ends of temples of a pair of eyeglasses respectively; thus, when a person wears the eyeglasses, the ear-propped parts will be hooked over rear portions of the wearer's ears so as to make the eyeglasses firm.

However, such an ear-propped device can't prevent eyeglasses from falling off when the wearer is doing drastic exercises.

Therefore, it is a main object of the present invention to provide an ear-propped device with an elastic band to overcome the above problem.

### SUMMARY OF THE INVENTION

An ear-propped device with an elastic band according to an embodiment of the invention includes two ear-propped parts, and an elastic band. Each ear-propped part includes a connecting portion to be joined to a corresponding temple of a pair of eyeglasses, and a hooking portion. The ear-propped parts are formed on two ends of the elastic band. In use, the ear-propped parts are joined to rear ends of temples of a pair of eyeglasses respectively, with the hooking portions thereof being hooked over hinder portions of the ears of the wearer of the eyeglasses, such that the eyeglasses and the elastic band together form a loop, and are tight around the wearer's head. Consequently, the eyeglasses are firm and prevented from falling off.

### BRIEF DESCRIPTION OF THE DRAWINGS

The present invention will be better understood by referring to the accompanying drawings, wherein:

FIG. 1 is a perspective view of an ear-propped device with an elastic band of the present invention,

FIG. 2 is a perspective view of the ear-propped device with an elastic band being going to be joined to a pair of eyeglasses,

FIG. 3 is a side view of a pair of eyeglasses with the ear-propped device joined thereto,

FIG. 4 is a perspective view of a second preferred embodiment of an ear-propped device with an elastic band in the invention, and

FIG. 5 is a side view of a pair of eyeglasses with the second preferred embodiment joined thereto.

### DETAILED DESCRIPTION OF THE PREFERRED EMBODIMENTS

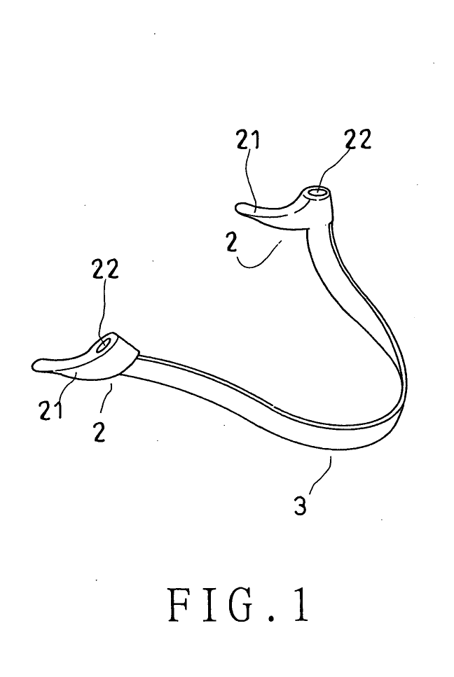

Shown in FIGS. 1 and. 2 is a first preferred embodiment of an ear-propped device with an elastic band of the present invention, which is joined to temples 11 of a pair of eyeglasses 1 so as to make the eyeglasses 1 firm on a wearer's face.

The ear-propped device includes two ear-propped parts 2 to be joined to the temples 11, and an elastic band 3. Each of the ear-propped parts 2 includes a hooking portion 21. And, each of the ear-propped parts 2 has a connecting portion 22 at a first end thereof for connection with the temples 11. And, the elastic band 3 connects both of the ear-propped parts 2 at two ends thereof.

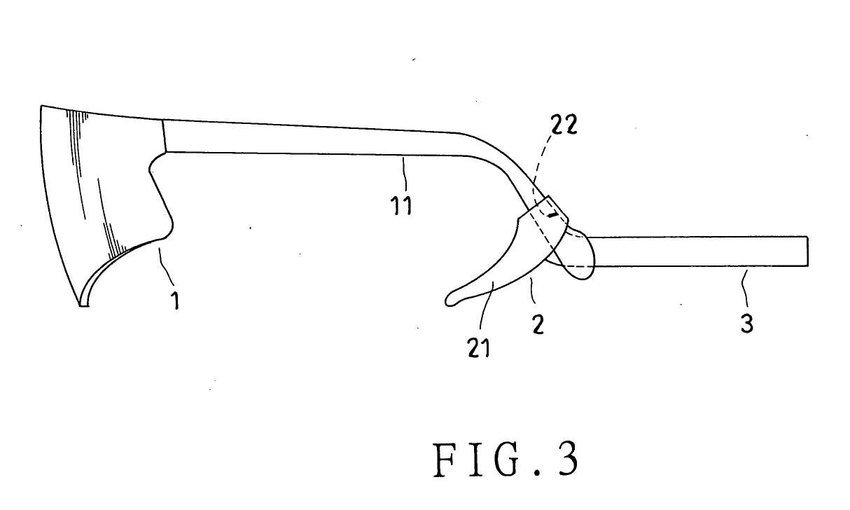

Furthermore, the hooking portions 21 of the ear-propped parts 2 are formed so as to have a curvature according to a curvature of joint between a human's ear and head. The elastic band 3 and the ear-propped parts 2 are formed together to be one part. The connecting portions 22 of the ear-propped parts 2 are formed by means of providing receiving holes on said first ends of the ear-propped parts 2 for the temples 11 to be inserted in, as shown in FIG. 3; after the ear-propped parts 2 are joined to the temples 11, there will be an angle between each of the hooking portions 22 of the ear-propped parts 2 and a corresponding temple 11, and the hooking portions 22 will be hooked over hinder portions of the wearer's ears to make the eyeglasses 1 firm on the wearer's face.

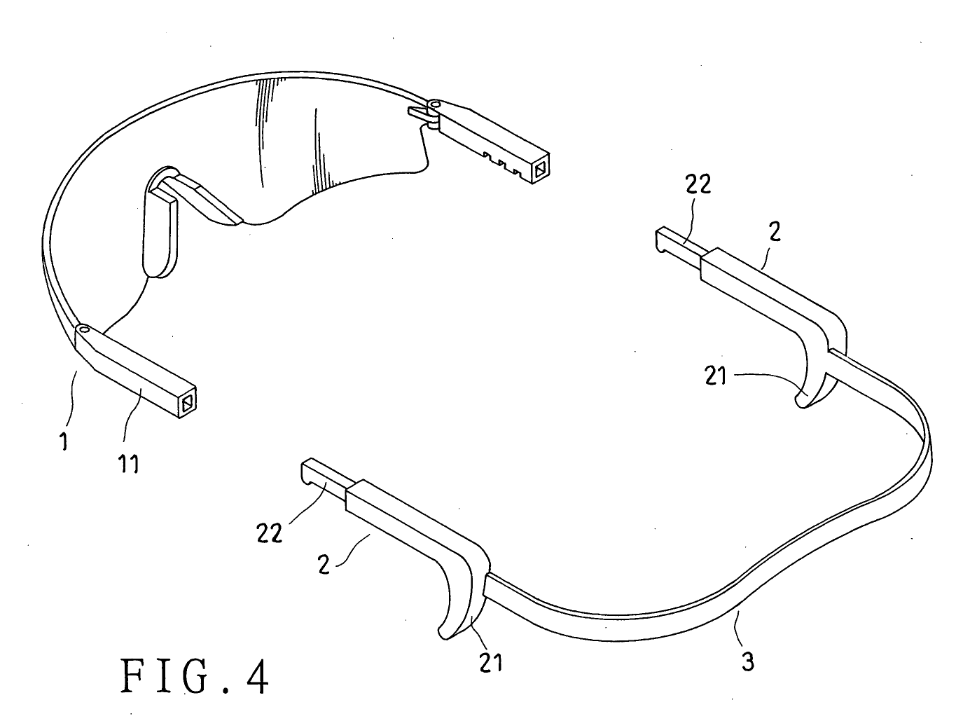

Shown in FIG. 4 is another preferred embodiment of an ear-propped device with an elastic band of the present invention; the ear-propped device includes two ear-propped parts 2, and an elastic band 3 connecting the ear-propped parts 2. Each of the ear-propped parts 2 includes a hooking portion 21, and a connecting portion 22. Furthermore, the connecting portion 22 of each of the ear-propped parts 2 is extended so as to have a fitting portion protruding from said first end of the ear-propped part 2. The fitting portions of the connecting portions 22 can be made to have such a shape as to be inserted in corresponding temple rear ends 11 of a pair of eyeglasses 1. Or alternatively, the fitting portions of the connecting portions 22 can be made to have such a shape as to allow corresponding temple rear ends 11 of a pair of eyeglasses 1 to be inserted therein.

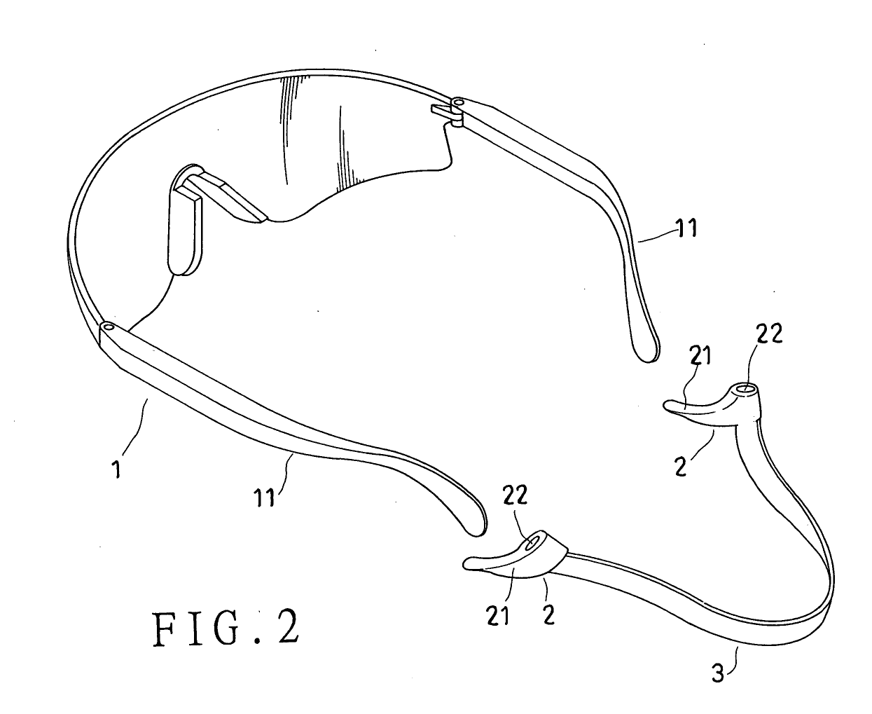

Referring to FIGS. 2 and 3, to use the first ear-propped device of the invention together with a pair of eyeglasses 1, first, the rear end of one of the temples 11 of the eyeglasses 1 is passed through the receiving hole of the connecting portion 22 of one said ear-propped part 2, and this ear-propped part 2 is adjusted so as to make the hooking portion 21 face down, and the user puts on the eyeglasses 1; thus, this hooking portion 21 is hooked over the hinder portion of the corresponding ear. Next, the elastic band 3 is stretched and passed over a hinder portion of the wearer's head, and the connecting portion 22 of the other ear-propped part 2 is joined to a rear end of the other temple 11; thus, the eyeglasses 1 and the elastic band 3 together become a loop, and are tight around the wearer's head, and in turn the eyeglasses 1 are firm on the wearer's face.

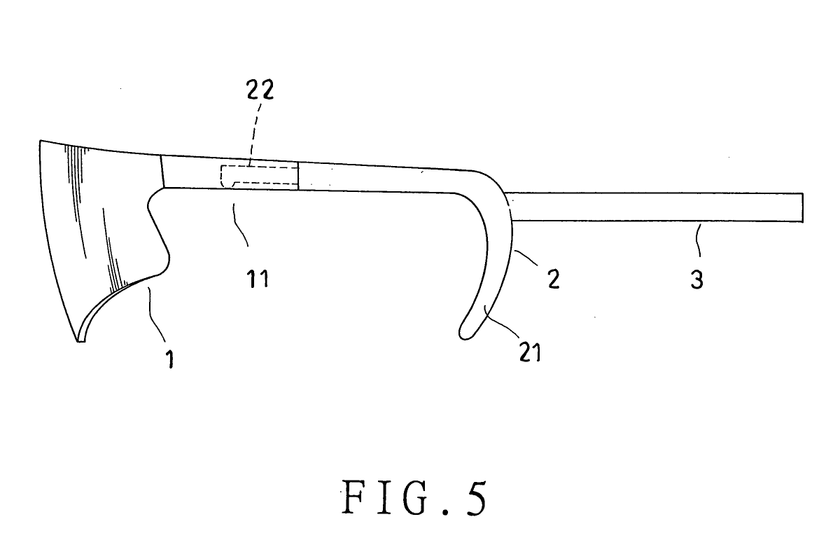

Referring to FIGS. 4 and 5, to use the second ear-propped device of the invention together with a pair of eyeglasses 1, first, the rear end of one of the temples 11 of the eyeglasses 1 is joined to the fitting portion of the connecting portion 22 of one said ear-propped part 2 so that the hooking portion 21 faces down. Next, the user puts on the eyeglasses 1; thus, this hooking portion 21 is hooked over the hinder portion of the corresponding ear. And, the elastic band 3 is stretched and passed over a rear of the wearer's head, and the fitting portion of the connecting portion 22 of the other ear-propped part 2 is joined to a rear end of the other temple 11; thus, the eyeglasses 1 and the elastic band 3 together form a loop, and are tight around the wearer's head, thus preventing the eyeglasses 1 from falling off.

From the above description, it can be seen that the ear-propped device with an elastic band of the present invention has an advantage: in use, the ear-propped parts are respectively joined to rear ends of temples of a pair of eyeglasses, and hooked over the hinder portions of the wearer's ears, and the elastic band and the eyeglasses together are tight around the wearer's head. Therefore, the eyeglasses are firm, and can't fall off even if the wearer is playing ball games or exercising drastically.

1. An ear-propped device with an elastic band, comprising:
two ear-propped parts, each of the ear-propped parts including a hooking portion with a curvature; each of the ear-propped parts having at a first end thereof a connecting portion to be joined to a corresponding temple of a pair of eyeglasses; and
an elastic band connecting both of the ear-propped parts; the elastic band and the ear-propped parts being formed together as one unit.

2. The ear-propped device with an elastic band as claimed in claim 1, wherein the connecting portions at said first ends of the ear-propped parts are formed with receiving holes.

3. The ear-propped device with an elastic band as claimed in claim 1, wherein each of the connecting portions at said first ends of the ear-propped parts is extended so as to have a fitting portion.
